(19) United States
(12) Patent Application Publication
(10) Pub. No.: US 2004/0167811 A1
(43) Pub. Date: Aug. 26, 2004

(54) Instant routing planning method

(76) Inventor: Chih-Hung Chien, Taoyuan (TW)

Correspondence Address: BIRCH STEWART KOLASCH & BIRCH, PO BOX 747, FALLS CHURCH, VA, 22040-0747, US

(21) Appl. No.: 10/360,652

(22) Filed: Feb. 10, 2003

(51) Int. Cl. G06F 17/60

(52) U.S. Cl. 705/8

(57) ABSTRACT

An instant routing planning method for arranging the retrieval path and the storage path of different materials in a warehouse. An optimal route is obtained together with the original information system in shortest possible time. The problem of a restricted retrieval and storage path owing to the principle of First In First Out is solved by the method of the invention.

### BACKGROUND OF THE INVENTION

1. Field of Invention

The invention is related to a method of routing planning in a warehouse, and more particularly to an instant routing planning method of determining the best retrieval path and picking the path instantly in a warehouse.

2. Related Art

The traditional warehouse or the distribution center is mostly managed manually. This method of allocating manpower has been substituted by recently introduced information systems. Manpower is also used for routing planning, including the assignment of retrieving and picking materials and the catalog of the orders. However, this often leads to a wide variation in retrieval and storage operations. The shipment time of goods and materials is sometimes affected seriously. The retrieval and storage path is easily in a mess. Furthermore, with manual labor a company cannot handle a huge quantity of orders.

Although the Automated Storage/Retrieval System (AS/RS) has been introduced in most distribution centers, the planning of retrieval and storage routing still necessitates the experience of the warehouse staff. The approach of utilizing manpower is only suitable for a small quantity of orders or in small warehouse. The best routing planning is not easily achieved in a short time when facing large warehouses having complicated paths or having a dynamic variation of needs. Therefore, what happens often is that the retrieval path or storage path is often linked together, the source is not sufficiently allocated, and the job is not finished on time.

A radio frequency terminal is often employed to link to the present automated warehouse system. For retrieval operations, the next material does not appear until the present material is picked. Thus, the path is bound with the sequence of the material shown in the radio frequency terminal. The retrieval sequence is traditionally arranged by the path. This is to say that the sequence is determined by the storage number from small to large or from large to small. The picking staff can adjust the retrieval sequence according the their experience because of using the hardcopy lists. But using the terminals is not in the situation. This means that the arrangement for the retrieval sequence has to be emphasized after introducing the automated system. A retrieval list with an inappropriate path causes the retrieval routing for the picking staff to not run smoothly. Time is not only wasted but also the walking distance of the picking staff increases. Therefore, a planning method having an instant path response to increase efficiency is greatly needed.

### SUMMARY OF THE INVENTION

The main object of the invention is to provide an instant routing planning method for arranging the retrieval path and the storage path of different goods and materials in a warehouse. Therefore the best retrieval path and storage path planning is completed in the shortest amount of time. The problem of the routing and long path is also solved by the disclosed invention.

The main flow chart of the method disclosed in the invention starts by establishing the weight of each section. The reference value of the weight is first determined, and then the best value for generating the weight is established. After the weight of each section is selected, a weight table is used to plan the new routing and output the routing. While picking materials, a moving distance of the warehouse system and time of picking materials is also obtained to renew the status of the warehouse and revise the weight table.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a flow chart of the method of instant routing planning of the invention.

FIG. 2 is a flow chart for determining the weight in the method of the invention.

### DETAILED DESCRIPTION OF THE INVENTION

The instant routing planning method disclosed in the invention is for finding a best path for retrieval and storage such that the automated warehouse system and the picking worker can pick and store the materials more efficiently. Generally, routing planning is focused on a dynamic storage area so that a planning strategy can be combined with the limits of the dynamic storage area, including the distinction between each storage area and the relationship of each storage area.

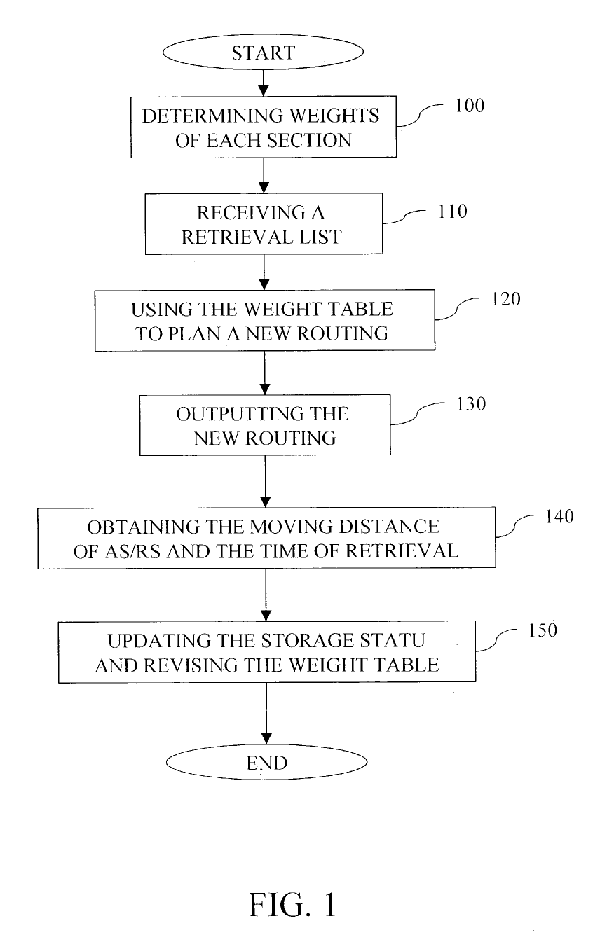

A preferred embodiment is offered to illustrate the viability of the method disclosed in the invention. Please refer to FIG. 1, which is a flow chart of the instant routing planning method. The details are described below.

The retrieval routing is sorted by the storage number and the sequence of picking materials must to be matched according to the principle of First In First Out. The weight of each section has to be determined first in order to simplify the calculations of routing and improve efficiency (Step 100). An optimal route is calculated by giving a weight to a section determined by retrieval equipment and the staff. After the weight is determined, the system receives a picking list (Step 110) and inputs the material data to be stored or picked. Then the system uses the weight table to plan a new route (Step 120). Since the routing rule is established in advance, the new route is output immediately (Step 130). The picking staff starts picking the materials after receiving the indication of storage and retrieval. The system records its movement and the retrieval status of materials through the FR terminals at the picking staff side such that an AS/RS moving distance and picking time are obtained (Step 140). The moving distance and the picking time are used to update the material status and feedback to revise the weight table (Step 150).

The concept of the weighted section can be used both in the traditional warehouse system and the automated warehouse system to increase the working efficiency of the staff and the running efficiency of the warehouse system. However, the characteristics of each section vary with the operation mode of the warehouse system, the distribution path, and the equipment.

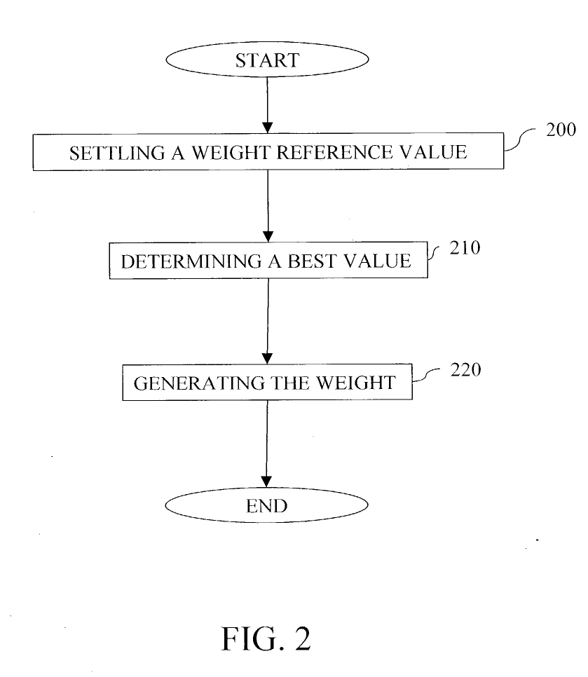

Please refer to FIG. 2, which is a flow chart for establishing the weight disclosed in the invention. The details are described as follows.

A weight reference value has to be determined (Step 200) before determining the weight. The reference value is obtained by separating the storage areas into small sections. Each section has the attributes of place, distance, height, usage equipment, and lists needed to be retrieved. For the automated warehouse system, the moving time of the equipment is defined in more detail through the section, and the next section is then determined according to the present retrieval type. Because the reference value of these sections affects the storage places of goods and materials, volume, weight and the picked quantity, an optimal value needs to be determined from these reference values (Step 210). The weight is not generated until an optimal value is determined (Step 220). The weight then is input into the system for planning the retrieval list. When a retrieval list is formed by the system, the route indicated by the system is not from small to large or from large to small but by the weight of each section. The waiting retrieval section is also taken into consideration for determining the next retrieval section to for optimizing the route. Therefore, the retrieval operation and the storage operation of the goods and materials can be arranged adequately. Not only is the distance of the routing shortened, but the retrieval operation and the storage operation also become more efficient.

The advantages of the invention can be understood in practice through the detailed description above. First, the weight table is adjustable by feedback of the retrieval status by using the weighted section. Second, the retrieval path is minimized and revised by the different storage status

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of instant routing planning for arranging the retrieval operation and the storage operation in a warehouse system, comprising the steps of:
determining a weight of a storage section, comprising the steps of:
settling a weight reference value;
determining a best value; and
generating the weight of the storage section;
inputting a retrieval list;
using the weight of the storage section and the retrieval list to plan a new routing;
outputting the routing;
obtaining a moving distance and a retrieval time of the system; and
updating the storage status of the system and revising the weight of the storage section.

2. The method of claim 1, wherein the warehouse system is a Automated Storage/Retrieval System (AS/RS).

3. The method of claim 1, wherein a radio frequency terminal is further accompanied with the warehouse system for transmitting data.

4. The method of claim 3, wherein the retrieval time is obtained by the switch of retrieval by the radio frequency terminal.

5. The method of claim 1, wherein the weight reference value is settled by group consisting of place, distance, height, using equipment, and lists needed to be retrieved.

6. The method of claim 1, wherein the weight of the storage section is revised by the moving distance and the retrieval time.

7. The method of claim 1, wherein the retrieval list is a storage list.

8. The method of claim 1, wherein the retrieval list is a picking list.
